(19) United States
(12) Patent Application Publication
(10) Pub. No.: US 2005/0028461 A1
(43) Pub. Date: Feb. 10, 2005

(54) Glass composite

(76) Inventor: Linda Czapka, Wien (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/497,940

(22) PCT Filed: Dec. 6, 2002
(86) PCT No.: PCT/AT02/00344

(30) Foreign Application Priority Data
Dec. 7, 2001 (AT) A1925/2001

(51) Int. Cl. E06B 9/01

(52) U.S. Cl. 52/204.6

(57) ABSTRACT

A glass compound is provided with two or several glass plates 1, 2 spaced apart A by a spacer 4, wherein between adjacent glass plates 1, 2 at least one inherently rigid plate element 3 is inserted whose thickness D is dimensioned to be smaller than the distance A between adjacent glass plates 1, 2 of the glass compound (FIG. 1).

The invention relates to a glass compound, in particular for use as a window, door or architectural element, especially for ornamental purposes or as a sunscreen, comprising two or several glass plates spaced apart by a spacer, wherein between adjacent glass plates an inherently rigid plate element is loosely inserted whose thickness is dimensioned to be smaller than the distance between adjacent glass plates of the glass compound. A glass compound of this kind is known, for instance, from EP-A1 0 324 710 and EP-A2 078 530. According to the former document, intermediate panes are arranged between adjacent glass plates, which panes are mounted to the outer edge of the glass compound by means of support pins; the latter document relates to a noise-protection glazing comprising a middle pane that has an undivided surface and extends across the entire surface of the glass compound.

Such known glass compounds do not allow any particular optical design of the middle pane, unless very high expenses are involved.

From GB-A 1 426 551, a glass compound is known that has a middle pane which is configured as a lead glazing in order to provide possibilities of optical design.

According to U.S. Pat. No. 6,138,433, a decorative element, which is translucent but forms one piece, is inserted in a double-pane glass compound. DE-A1 42 26 883 shows that a glass compound comprising more than two glass plates spaced apart by a spacer is known.

From U.S. Pat. No. 4,975,307 A, a glass compound is known according to which an inherently rigid plate element is provided between adjacent glass plates, which plate element is configured so as to be multipart, with the parts lying on one plane, directly abutting each other with their peripheral rims, yet being glued to the glass plates.

DE 27 07 398 A shows a plate element between two glass panes, which, however, is configured as one piece. As a result of the large distance between the glass panes, the plate element inserted between them is supported relative to each glass pane by means of resilient supports, whereby the resilient supports are provided in the rim areas of the plate element, namely in the areas that are oriented in parallel to the glass panes.

EP 0 721 086 A relates to a disk lamp composed of two glass panes with an optical-fibre plate inserted therebetween. Above at least one edge of the optical-fibre plate, a cavity for receiving a light source is provided.

The object of the invention is to provide a glass compound of the initially described kind involving a possibility of optical design that can easily be technically realized, wherein almost no limits are set in particular to artistic creativity.

With a glass compound of the initially described kind, said object is achieved in that several in-plane plate elements are inserted between two adjacent glass plates, the total surface of said elements preferably roughly corresponding to the total surface of the glass compound, with adjacent plate elements directly abutting each other with their peripheral rims, and in that the thickness of the plate elements, according to the possible thermal expansions of said elements, is dimensioned to be smaller than the distance between adjacent glass plates.

If the glass compound is exposed to fluctuations of temperature, such as f.i. when being used as a window or door element, the plate element is suitably supported at the edge on the glass compound by a resilient support element.

The thickness of the plate element is dimensioned to be smaller than the distance between adjacent glass plates of the glass compound, according to the possible thermal expansions of said element, so as to avoid the occurrence of interference phenomena even in case of quite large fluctuations of temperature.

A particularly decorative design of the glass compound is characterized in that the plate element is transparent, in particular colourless or coloured, whereby the plate element advantageously is manufactured from a synthetic material, in particular as an acrylic glass plate.

It has turned out to be advantageous that the plate element is supported at the edge on the spacer by a resilient support element and that—in particular if several plate elements are arranged—it surrounds those elements in the assembled state. Advantageously, a plate comprised of several plate elements can be used, which then is supported at the edge on the spacer by a resilient support element.

The resilient support element is preferably made of silicone and is suitably configured as a silicone tube, wherein, if the position of the glass compound deviates from a horizontal position, the resilient support element advantageously is shaped in the rim area of the plate element, which rim area serves as a base, in order to receive forces that are larger than in other rim areas surrounding the plate element. Such a formation is particularly suitable for the vertical arrangement of a glass compound.

For window and door elements, the glass compound is suitably characterized in that adjacent glass plates are arranged at a distance of 6 to 12 mm, preferably 8 to 10 mm.

Advantageously, the distance between adjacent glass plates is dimensioned to be larger by 2% to 45%, preferably by 10% to 20%, than the thickness of a plate element.

Advantageously, the edges of adjacent plate elements positively interlock on one level in order to secure the position of adjacent plate elements.

A technically particularly simple construction is characterized in that the spacer and the resilient support element are configured as a building unit.

A particularly attractive embodiment is characterized in that a light source is attached to the edge of at least one plate element, the light source advantageously being inserted in a recess of a plate element.

The light is introduced to the plate element particularly well if the light source is in direct contact with the plate element, whereby the direction of radiation of the light source advantageously is oriented in the direction of the plane of a plate element.

A light-emitting diode and/or a laser diode preferably serves as the source of light.

In the following, the invention is illustrated in further detail with respect to the drawing, wherein

FIG. 1 shows a cross-section through a glass compound of the type according to the invention and

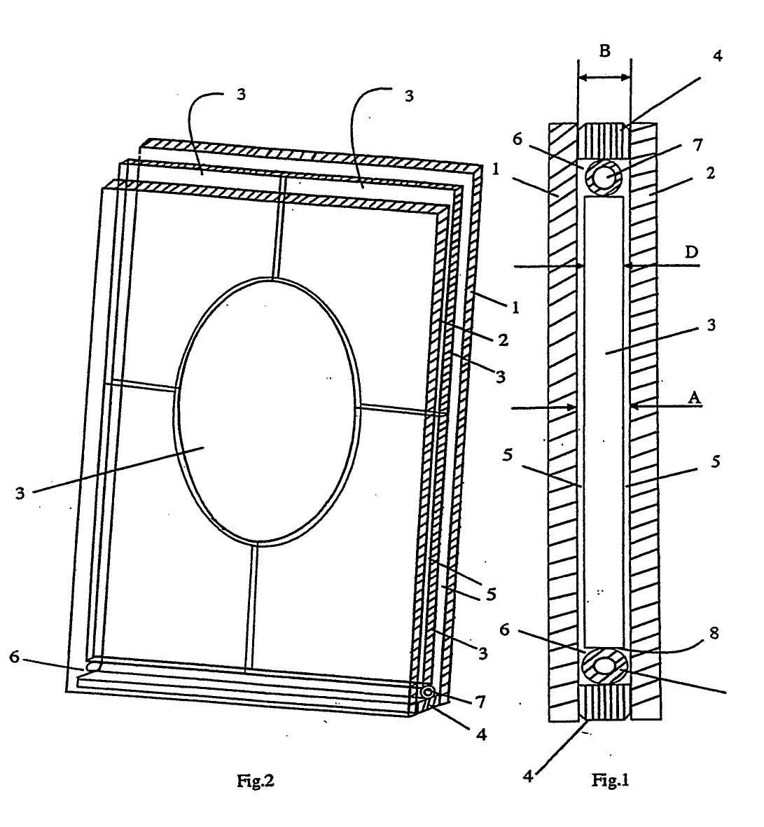

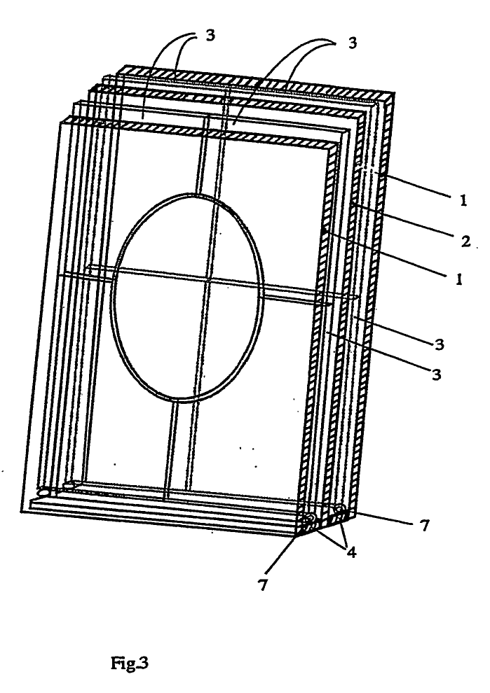

FIG. 2 shows a cutout from such a glass compound in the diagonal section.

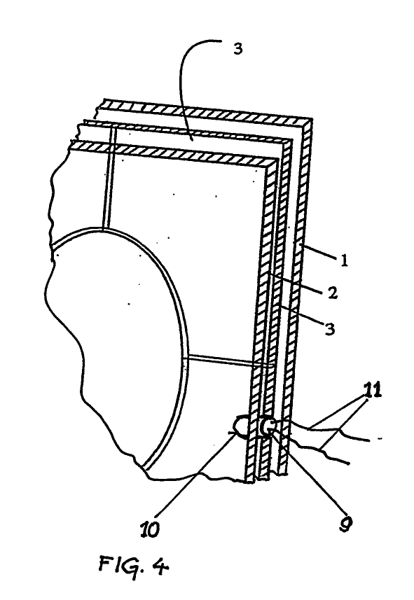

FIG. 3 shows the formation of a glass compound composed of three glass plates in analogy to FIG. 2

FIG. 4 shows an embodiment of the glass compound that has a light source in an illustration analogous to FIG. 2.

A plate element 3 such as an acrylic glass plate 3 of appx. 6 mm (or 7 mm or 8 mm)—or a plate element made of another synthetic material—is placed between two glass plates 1, 2 of a glass compound that are spaced apart at a distance A and are combined by a spacer 4 having a width B of 8 mm (or 10 mm). The coloured transparent or colourless acrylic glass plate 3 (f.i. PMMA polymethylmethacrylate), which was cut by laser, may thus be used in the glass compound as a shaped and coloured window, door or architectural element, f.i. as a furniture element or a sightscreen element, whereby it can assume the function of a sunscreen due to its material property (filtering ultraviolet light). In the illustrated exemplary embodiment, several plate elements 3, i.e. several acrylic glass plates 3, are assembled in a unit.

If an arbitrary number of acrylic glass plates 3 is configured as a unit, the elements are assembled like in a puzzle so as to form a complete plate comprised of several plate elements 3, which plate remains whole without adhesive sealing due to the selected narrow distances to the glass plates 1, 2 and cannot get displaced even during transport. Geometrical shapes and graphic characters but also any other kind of image which can be realized by the method (the abutting edges of the varicoloured elements form the preliminary drawing) appear to be particularly suitable for designs.

A multipart acrylic plate 3 is coated, only for the assembly, on both sides with a detachable protective film which is peeled off during assembly so that, with ease, the plate can as a whole be integrated in the glass compound.

In order to take into account the thermally induced expansion of the material of the plate element 3 and to avoid the occurrence of interference phenomena, respectively, a clearance 5 between the acrylic glass plate 3 and the glass plates 1 and 2, preferably of at least 1-2 mm in each case (up to 2 mm in each case, if the acrylic glass has a material thickness of 8 mm) must be observed, which clearance is dimensioned depending on the thickness D of the plate element 3 or of the acrylic glass plate 3, respectively, as well as on the maximum thermal expansions to be expected. At the lateral edges of the glass compound, a clearance 6 corresponding to the size of the acrylic glass plate 3 is to be chosen, also because of the thermally induced expansion. Said clearance is balanced by silicone tubes 7 (diameter 5-8 mm) inserted along the lateral rims, which slacken upon the expansion of the acrylic glass plate 3 and, at the same time, support the structure of a multipart acrylic glass plate 3 as a whole. In doing so, a stronger silicone tube 7 (diameter 6-9 mm) must be used at the lower lateral edge 8 because of the weight of the acrylic glass plate 3.

In said glass compound which, also for reasons of f.i. fire protection or heat insulation, may also consist of several glass panes—see FIG. 3—, acrylic glass is characterized by a small dead weight, the possibility of exact processing in complex designs and stability with respect to transport, jolting etc.

Metal springs, plastic clips or glass elements may also serve as spacers 4 between the adjacent glass plates 1, 2.

As material for a plate element 3, not only synthetic materials such as acrylic glass come into consideration, although they have proven to be of particular value, but also wood, metal or mineral materials such as marble, semi-precious stones etc. can likewise be used. A plate element 3 may also be provided with holes. No limits are set to the freedom of creative expression.

For particular applications, such as f.i. when being used as a table top, the glass compound can even go without any resilient support elements 7 at the edge. This is the case, in particular, if no or almost no fluctuations of temperature are to be expected for the glass compound.

The glass compound according to the invention can also be used as a noise-protection element.

According to the glass compound illustrated in FIG. 3, three glass panes 1, 2 arranged in parallel to each other are provided, and one plate element 3 at a time, in the illustrated exemplary embodiment several plate elements 3 at a time, are inserted between the first 1 and the middle glass panes 2 as well as between the middle 2 and the last glass panes 1.

According to the embodiment illustrated in FIG. 4, a glass compound is equipped with a light source 9. Said light source is inserted in a recess 10 of at least one plate element 3, wherein the orientation of the light source 9 is chosen such that the main direction of radiation of the light source is oriented in the direction of the plane of the plate element 3. Current-supply wires 11 are led outward either through the spacers 4 or between the spacer and the glass plates 1, 2, whereby the impermeability of the glass compound is maintained.

The light fed into a plate element 3 is reflected on the surfaces of said element, and scattering or emission, respectively, occurs only at the peripheral rim of a plate element 3, which might lead to particularly attractive edge effects. The type of the surface condition of the plate element 3 also allows for a partial emission of light and hence the creation of a light effect on a surface, for instance, if said surface is roughened. By means of a reflection lacquer, a total reflection of light can be achieved.

For the light supply to the plate element 3, it is important that the light source 9, in the illustrated exemplary embodiment a light-emitting diode, is directly attached to the plate element 3, preferably without clearance, i.e. involving a direct contact and in a manner that is as dust-free as possible, so that scatterings during the supply of light are avoided if at all possible.

1. A glass compound, in particular for use as a window, door or architectural element, especially for ornamental purposes or as a sunscreen, comprising two or several glass plates (1, 2) spaced apart (A) by a spacer (4), wherein between adjacent glass plates (1, 2) an inherently rigid plate element (3) is loosely inserted whose thickness (D) is dimensioned to be smaller than the distance (A) between adjacent glass plates (1, 2) of the glass compound, characterized in that several in-plane plate elements (3) are inserted between two adjacent glass plates (1, 2), the total surface of said elements preferably roughly corresponding to the total surface of the glass compound, with adjacent plate elements (3) directly abutting each other with their peripheral rims, and in that the thickness (D) of the plate elements (3), according to the possible thermal expansions of said elements, is dimensioned to be smaller than the distance (A) between adjacent glass plates (1, 2).

2. A glass compound according to claim 1, characterized in that a plate element (3) is supported at the edge on the glass compound by a resilient support element (7).

3. A glass compound according to claim 1, characterized in that a plate element (3) is transparent, in particular colourless or coloured.

4. A glass compound according to claim 1, characterized in that a plate element (3) is manufactured from a synthetic material, in particular as an acrylic glass plate.

5. A glass compound according to claim 2, characterized in that a plate element (3) is supported at the edge on the spacer by the resilient support element (7) and that—in particular if several plate elements (3) are arranged—it surrounds those elements in the assembled state.

6. A glass compound according to claim 2, characterized in that the resilient support element (7) is made of silicone and preferably is configured as a silicone tube.

7. A glass compound according to claim 2, characterized in that, if the position of the glass compound deviates from a horizontal position, the resilient support element (7) is shaped in the rim area of the plate element (3), which rim area serves as a base (at 8), in order to receive forces that are larger than in other rim areas surrounding the plate element (3).

8. A glass compound according to claim 1, characterized in that adjacent glass plates (1, 2) are arranged at a distance of 6 to 12 mm, preferably 8 to 10 mm.

9. A glass compound according to claim 1, characterized in that the distance (A) between adjacent glass plates (1, 2) is dimensioned to be larger by 2% to 45%, preferably by 10% to 20%, than the thickness (D) of a plate element (3).

10. A glass compound according to claim 1, characterized in that the edges of adjacent plate elements (3) positively interlock on one level in order to secure the position of adjacent plate elements.

11. A glass compound according to claim 2, characterized in that the spacer (4) and the resilient support element (7) are configured as a building unit.

12. A glass compound according to claim 1, characterized in that a light source (9) is attached to the edge of at least one plate element (3).

13. A glass compound according to claim 12, characterized in that the light source (9) is inserted in a recess (10) at the edge of a plate element (3).

14. A glass compound according to claim 12 or 13, characterized in that the light source (9) is in direct contact with the plate element (3).

15. A glass compound according to claim 12, characterized in that the direction of radiation of the light source (9) is oriented in the direction of the plane of a plate element (3).

16. A glass compound according to claim 12, characterized in that a light-emitting diode and/or a laser diode is provided as the source of light (9).
